(19) United States
(12) Patent Application Publication
(10) Pub. No.: US 2026/0145961 A1
(43) Pub. Date: May 28, 2026

(54) METHOD FOR PRODUCING MOLYBDENUM TRIOXIDE POWDER

(71) Applicant: DIC Corporation, Tokyo (JP)

(72) Inventors: Koki Hirabayashi, Sakura-shi (JP); Jianjun Yuan, Sakura-shi (JP)

(73) Assignee: DIC Corporation, Tokyo (JP)

(21) Appl. No.: 19/362,531

(22) Filed: Oct. 20, 2025

(30) Foreign Application Priority Data
Nov. 26, 2024 (JP) 2024-205239

(51) Int. Cl. C01G 39/02

(52) U.S. Cl. CPC C01G 39/02; C01P 2002/50; C01P 2004/64; C01P 2006/12

(57) ABSTRACT

To provide a method for producing molybdenum trioxide powder capable of reducing material costs and decreasing environmental burden and disposal costs associated with disposal of by-products generated during calcination. The present invention provides a method for producing molybdenum trioxide powder, the method containing: a first calcining step S11 of charging a first raw material mixture containing a molybdenum oxide precursor compound and metal compound particles other than molybdenum compounds into a sagger and calcining the mixture; a first cooling step S12 of generating molybdenum trioxide powder; a first crushing step S13 of crushing a residue containing a metal oxide derived from the metal compound particles which remains in the sagger, to obtain first crushed particles; a second calcining step S21 of charging a second raw material mixture containing the molybdenum oxide precursor compound and the first crushed particles into a sagger and calcining the mixture; a second cooling step S22 of generating molybdenum trioxide powder; and a second crushing step S23 of crushing a residue containing a metal oxide derived from the first crushed particles which remains in the sagger, to obtain second crushed particles.

### CROSS-REFERENCE TO RELATED APPLICATIONS

This application claims the benefit of and priority to Japanese Patent Application No. 2024-205239, filed on Nov. 26, 2024, and the content thereof is incorporated herein by reference in its entirety.

### TECHNICAL FIELD

The present invention relates to a method for producing molybdenum trioxide powder.

### BACKGROUND ART

Conventionally, molybdenum sulfides such as molybdenum disulfide (MoS₂) have been widely used, for example, as lubricants, steel additives, and molybdate raw materials. As a method for producing molybdenum sulfide, a method using molybdenum trioxide powder as a precursor is known.

Conventionally, a method for producing molybdenum trioxide powder includes vaporizing a molybdenum oxide precursor compound to form molybdenum trioxide vapor and cooling the molybdenum trioxide vapor.

For example, Patent Literature 1 proposes a method for producing molybdenum trioxide powder, in which a raw material mixture containing a molybdenum oxide precursor compound and metal compounds other than the molybdenum oxide precursor compound is fired, the molybdenum oxide precursor compound is vaporized, and molybdenum trioxide vapor is formed.

Furthermore, Patent Literature 1 describes mixing aluminum hydroxide and molybdenum trioxide, charging the mixture into a sagger, calcining it at a temperature of 1100° C., and recovering the molybdenum trioxide using a dust collector. Moreover, Patent Literature 1 discloses that aluminum oxide was removed from the sagger after the calcining process.

### CITATION LIST

### Patent Literature

PTL1: WO2022/202757

### SUMMARY OF INVENTION

However, in the case of producing molybdenum trioxide powder by a method in which a raw material mixture containing aluminum hydroxide and molybdenum trioxide is fired, it has been necessary to prepare a large amount of aluminum hydroxide as a material. Accordingly, there has been a demand for reducing the amount of aluminum hydroxide used and decreasing material costs.

Moreover, in the case of producing molybdenum trioxide powder by the above method, aluminum oxide is generated as a by-product from the aluminum hydroxide during calcination. Accordingly, when producing molybdenum trioxide powder by the above method, it is necessary to dispose of the aluminum oxide which is a by-product, and there has been a demand for reducing the environmental burden and disposal costs associated with the disposal of the aluminum oxide.

In order to solve the above problems, only molybdenum trioxide may be used as a material, without using aluminum hydroxide, which is a raw material of the by-product. However, the aluminum hydroxide contained in the raw material mixture has a function of retaining the molybdenum trioxide, which melts and liquefies when the raw material mixture charged into the sagger is fired, and a function of protecting the sagger by reducing the contact area between the liquefied molybdenum trioxide and the sagger.

Accordingly, for example, when only molybdenum trioxide is used as a raw material, the liquefied molybdenum trioxide produced by calcining may leak from the sagger, or may come into contact with the sagger and cause severe corrosion and deterioration thereof. Therefore, it is preferable that the raw material mixture contain a sufficient amount of aluminum hydroxide together with molybdenum trioxide. Thus, it has been difficult to use only molybdenum trioxide as a raw material.

The invention has been made in view of the above problems, and an object thereof is to provide a method for producing molybdenum trioxide powder which can reduce material costs and decrease environmental load and disposal costs associated with disposal of by-products generated by calcining.

In order to solve the above problems, and to reduce material costs as well as environmental load and disposal costs associated with disposal of by-products generated by calcining, the present inventors focused on the material to be mixed in the raw material mixture together with molybdenum trioxide and on the by-product generated by calcining the raw material mixture, and have made extensive studies as described below.

That is, in the case of producing molybdenum trioxide powder by a method of calcining a raw material mixture containing aluminum hydroxide and molybdenum trioxide, it was conceived that the residue containing aluminum oxide remaining in the sagger after calcination could be reused as a material for molybdenum trioxide powder.

However, since the residue remaining in the sagger after calcination is lump-shaped, it cannot sufficiently exhibit either the function of retaining molybdenum trioxide that has melted and liquefied or the function of reducing the contact area between the molybdenum trioxide that has melted and liquefied and the sagger.

Accordingly, the present inventors crushed the lump-shaped residue containing aluminum oxide remaining in the sagger into aluminum oxide particles. The resulting aluminum oxide particles were charged in the sagger together with a molybdenum oxide precursor compound and fired. As a result, it was found that the alumina particles can sufficiently suppress the leakage of molybdenum trioxide that has melted and liquefied during calcination from the sagger, as well as the degradation of the sagger caused by the liquefied molybdenum trioxide.

That is, the inventors found that by crushing the lump-shaped alumina generated as a by-product to obtain alumina particles, it can be reused as a material when producing molybdenum trioxide powder.

Furthermore, the present inventors conducted extensive studies and confirmed the following (a) and (b), thereby achieving the invention.

(a) Even when a raw material mixture containing a molybdenum oxide precursor compound together with metal compound particles other than molybdenum compounds, such as aluminum hydroxide, magnesium aluminate, titanium oxide, iron oxide, zinc oxide, and silica, is charged in a sagger and fired, lump-shaped residues are generated in the sagger after calcination.
(b) By crushing the lump-shaped residue generated in (a) to form particles, charging them into a sagger together with the molybdenum oxide precursor compound and calcining the mixture, it is possible to sufficiently suppress, in the same manner as when metal oxides including alumina particles are charged into a sagger and fired, both the leakage of molybdenum trioxide that has melted and liquefied during calcination from the sagger and the degradation of the sagger caused by the liquefied molybdenum trioxide.
The present invention provides the following means.

[1] A method for producing molybdenum trioxide powder, the method including: a first calcining step of charging a first raw material mixture, which contains a molybdenum oxide precursor compound and metal compound particles other than molybdenum compounds, in a sagger, calcining the mixture, and vaporizing the molybdenum oxide precursor compound to form molybdenum trioxide vapor;
a first cooling step of cooling the molybdenum trioxide vapor produced in the first calcining step to generate molybdenum trioxide powder;
a first crushing step of crushing a residue containing a metal oxide derived from the metal compound particles which remains in the sagger after the first calcining step, to obtain first crushed particles;
a second calcining step of charging a second raw material mixture, which contains the molybdenum oxide precursor compound and the first crushed particles, in a sagger, calcining the mixture, and vaporizing the molybdenum oxide precursor compound to form molybdenum trioxide vapor;
a second cooling step of cooling the molybdenum trioxide vapor produced in the second calcining step to generate molybdenum trioxide powder;
a second crushing step of crushing a residue containing a metal oxide derived from the first crushed particles which remains in the sagger after the second calcining step, to obtain second crushed particles.

[2] The method for producing molybdenum trioxide powder according to the above item [1], in which the average particle diameter of the first crushed particles and the second crushed particles is 1 mm or less.

[3] The method for producing molybdenum trioxide powder according to the above item [1] or [2], in which the metal compound particles are one or more selected from alumina particles, magnesium aluminate particles, titanium oxide particles, iron oxide particles, zinc oxide particles, and silica particles.

[4] The method for producing molybdenum trioxide powder according to the above item [3], in which the first raw material mixture contains the molybdenum oxide precursor compound and the metal compound particles, and in the first calcining step, calcining is performed at a temperature of 800° C. or higher and 1200° C. or lower, and in which the second raw material mixture contains the molybdenum oxide precursor compound and the first crushed particles, and in the second calcining step, calcining is performed at a temperature of 800° C. or higher and 1200° C. or lower.

[5] The method for producing molybdenum trioxide powder according to the above item [3] or [4], in which the first raw material mixture contains the metal compound particles in an amount of 50 to 200 mass % relative to 100 mass % of the molybdenum oxide precursor compound, and in which the second raw material mixture contains the first crushed particles in an amount of 50 to 200 mass % relative to 100 mass % of the molybdenum oxide precursor compound.

[6] The method for producing molybdenum trioxide powder according to any one of the above items [1] to [5], in which molybdenum trioxide powder having an average particle diameter of 5 nm or greater and 100 nm or less is produced in the first cooling step and the second cooling step.

[7] The method for producing molybdenum trioxide powder according to any one of the above items [1] to [6], in which molybdenum trioxide powder having a specific surface area of 10 m²/g or greater and 500 m²/g or less, measured by the BET method, is produced in the first cooling step and the second cooling step.

[8] The method for producing molybdenum trioxide powder according to any one of the above items [1] to [7], in which molybdenum trioxide powder containing a β-crystal structure is produced in the first cooling step and the second cooling step.

In the method for producing molybdenum trioxide powder of the invention, in a first calcining step, metal compound particles other than molybdenum compounds are used together with a molybdenum oxide precursor compound; in a first crushing step, a residue remaining in a sagger during calcination, the residue containing a metal oxide derived from the metal compound particles, is crushed to obtain first crushed particles; and in a second calcining step, the first crushed particles are used together with a molybdenum oxide precursor compound.

Accordingly, in the method for producing molybdenum trioxide powder of the invention, a residue containing a metal oxide derived from the metal compound particles other than molybdenum compounds used in the first calcining step is crushed in the first crushing step to obtain first crushed particles, and is reused as a material in the second calcining step.

Therefore, in the method for producing molybdenum trioxide powder of the invention, for example, as compared with the case where a residue containing a metal oxide derived from metal compound particles other than molybdenum compounds contained in the first raw material mixture is not reused, the material cost can be reduced.

In addition, in the method for producing molybdenum trioxide powder of the invention, the residue remaining in the sagger during calcination is crushed to obtain first crushed particles, which are reused in the second calcining step. Accordingly, there is no need to dispose of the residue remaining in the sagger after calcination, and no environmental burden or disposal cost arises as in the case where the residue remaining in the sagger during calcination is disposed of.

### BRIEF DESCRIPTION OF DRAWINGS

FIG. 1 is a schematic diagram illustrating an example of a molybdenum trioxide powder production apparatus 1 used in the method for producing molybdenum trioxide powder according to the present embodiment, including a calcining furnace 2, cooling pipe 3, a dust collection device 4, an exhaust port 5, an adjustable opening-degree damper 6 for adjusting opening, an observation window 7, an exhaust device 8, and an external cooling device 9.

FIG. 2 is a flowchart illustrating an example of the method for producing molybdenum trioxide powder according to the present embodiment, including a first calcining step S11, a first cooling step S12, a first crushing step S13, a second calcining step S21, a second cooling step S22, and a second crushing step S23.

### DESCRIPTION OF EMBODIMENTS

Hereinafter, a method for producing molybdenum trioxide powder according to the present embodiment will be described in detail with reference to the drawings as appropriate. It should be noted that the drawings used in the following description may, for convenience, show enlarged views of characteristic portions in order to make the features of the invention easier to understand. Therefore, dimensional ratios and the like of the respective components may differ from those in actual practice. The scope of the invention is not limited to the embodiment described here, and various modifications can be made without departing from the spirit of the invention. In addition, where multiple upper limit values and lower limit values for specific parameters are described, any combination of an upper limit value and a lower limit value among these can be employed to define a preferable numerical range.

### [Production Apparatus for Molybdenum Trioxide Powder]

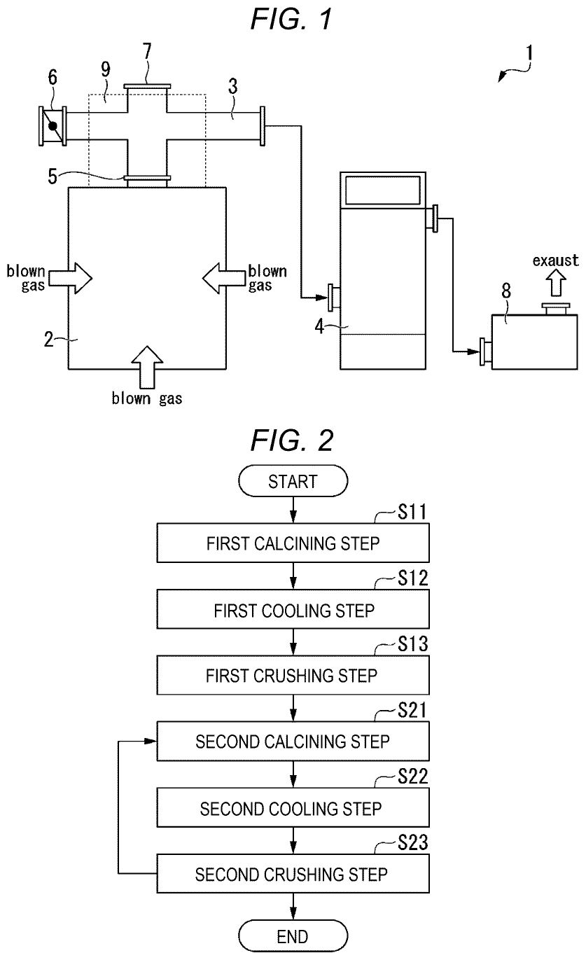

FIG. 1 is a schematic diagram illustrating an example of a production apparatus for molybdenum trioxide powder used in the method for producing molybdenum trioxide powder according to the present embodiment.

As shown in FIG. 1, the production apparatus 1 for molybdenum trioxide powder includes a calcining furnace 2, a cooling pipe 3, a dust collection device 4, and an exhaust device 8.

The calcining furnace 2 fires a raw material mixture containing a molybdenum oxide precursor compound charged in a sagger (not shown) under predetermined calcination conditions and vaporizes the molybdenum oxide precursor compound. Any known calcining furnace can be used as the calcining furnace 2. As shown in FIG. 1, an exhaust port 5 is provided in the ceiling of the calcining furnace 2.

The cooling pipe 3 cools the molybdenum trioxide vapor, which is generated by calcining and vaporizing the raw material mixture containing the molybdenum oxide precursor compound in the calcining furnace 2, to form a powder. As shown in FIG. 1, the cooling pipe 3 has a cross-shaped configuration in sideview. The lower end of the cooling pipe 3 is connected to the exhaust port 5 of the calcining furnace 2. An observation window 7 for observing the interior of the cooling pipe 3 is provided at the upper end of the cooling pipe 3.

A fresh air inlet (not shown) is provided at the first horizontal end of the cooling pipe 3. As shown in FIG. 1, an adjustable opening-degree damper 6 for adjusting the opening of the fresh air inlet is arranged at the fresh air inlet.

A dust-collection pipe is connected to a second horizontal end of the cooling pipe 3. As shown in FIG. 1, the dust-collection pipe connects the cooling pipe 3 to the dust collection device 4.

The production apparatus 1 for molybdenum trioxide powder according to the present embodiment may be provided, as necessary, with a known external cooling device (indicated by reference numeral 9 in FIG. 1) for cooling the cooling pipe 3 from the outside.

The dust collection device 4 collects the molybdenum trioxide powder that has been powdered in the cooling pipe 3. As the dust collection device 4, for example, a device can be used that recovers the molybdenum trioxide powder contained in a gas supplied from the cooling pipe 3 by passing the gas through a filter such as a bag filter.

The exhaust device 8 draws gas from the dust collection device 4 through a suction pipe, as shown in FIG. 1. Any known device, such as a blower, can be used as the exhaust device 8.

In the production apparatus 1 for molybdenum trioxide powder shown in FIG. 1, the exhaust device 8 draws the dust collection device 4 through the suction pipe. Then, cooling pipe 3, which is connected to the dust collection device 4 via the dust-collection pipe, is drawn. As a result, the gas inside the cooling pipe 3 is discharged, and fresh air is blown into the cooling pipe 3 from the adjustable opening-degree damper 6.

### [Method for Producing Molybdenum Trioxide Powder]

Next, as an example of a method for producing molybdenum trioxide powder according to the present embodiment, a case in which molybdenum trioxide powder is produced using the production apparatus 1 for molybdenum trioxide powder shown in FIG. 1 will be described in detail.

FIG. 2 is a flowchart illustrating an example of a method for producing molybdenum trioxide powder according to the present embodiment. As shown in FIG. 2, the method for producing molybdenum trioxide powder according to the present embodiment includes a first calcining step S11, a first cooling step S12, a first crushing step S13, a second calcining step S21, a second cooling step S22, and a second crushing step S23. As shown in FIG. 2, the second calcining step S21, the second cooling step S22, and the second crushing step S23 may be performed repeatedly a plurality of times after the first crushing step S13, or may be performed only once.

### (First Calcining Step S11)

In the first calcining step S11, a first raw material mixture containing a molybdenum oxide precursor compound and a metal compound particle other than a molybdenum compound is charged in a sagger and fired in the calcining furnace 2 shown in FIG. 1, thereby vaporizing the molybdenum oxide precursor compound to form molybdenum trioxide vapor.

The molybdenum oxide precursor compound contained in the first raw material mixture may be any compound capable of forming molybdenum trioxide vapor upon calcining, and is not particularly limited.

The form of the molybdenum oxide precursor compound contained in the first raw material mixture is not particularly limited. For example, it may be in a powder form such as molybdenum trioxide powder, or a liquid such as an aqueous solution of ammonium molybdate. The form of the molybdenum oxide precursor compound is preferably a powder form, because the form is easy to handle and has good energy efficiency.

Examples of the molybdenum oxide precursor compounds contained in the first raw material mixture include metallic molybdenum, molybdenum trioxide, molybdenum dioxide, molybdenum disulfide, ammonium molybdate, phosphomolybdic acid (H₃PMo₁₂O₄₀), silicomolybdic acid (H₄SiMo₁₂O₄₀), aluminum molybdate, silicon molybdate, magnesium molybdate (MgMoₙO₃ₙ₊₁, n=1 to 3), sodium molybdate (Na₂MoₙO₃ₙ₊₁, n=1 to 3), titanium molybdate, iron molybdate, potassium molybdate (K₂MoₙO₃ₙ₊₁, n=1 to 3), zinc molybdate, boron molybdate, lithium molybdate (Li₂MoₙO₃ₙ₊₁, n=1 to 3), cobalt molybdate, nickel molybdate, manganese molybdate, chromium molybdate, cesium molybdate, barium molybdate, strontium molybdate, yttrium molybdate, zirconium molybdate, copper molybdate. These molybdenum oxide precursor compounds may be used alone or in combination of two or more thereof.

The molybdenum oxide precursor compounds contained in the first raw material mixture preferably include molybdenum trioxide from the viewpoint of easily controlling the purity, average particle size, and crystal structure of the molybdenum trioxide powder to be produced. In particular, it is preferable to use commercially available α-crystalline molybdenum trioxide as the molybdenum oxide precursor compound. In addition, when ammonium molybdate is used as the molybdenum oxide precursor compound, since it is converted into thermodynamically stable molybdenum trioxide by calcining, the molybdenum oxide precursor compound to be vaporized is molybdenum trioxide.

Examples of the metal compound particles other than molybdenum compounds contained in the first raw material mixture include alumina particles, magnesium aluminate particles, titanium oxide particles, iron oxide particles, zinc oxide particles, and silica particles. One type of metal compound particles other than molybdenum compounds may be used alone, or two or more types thereof may be used in combination.

The metal compound particles other than molybdenum compounds contained in the first raw material mixture preferably comprise particles containing metal oxides that do not react with the molybdenum oxide precursor compound upon calcining. Examples of the particles containing metal oxides that do not react with the molybdenum oxide precursor compound include particles containing one or two or more metal oxides selected from alumina particles, magnesium aluminate particles, titanium oxide particles, iron oxide particles, zinc oxide particles, and silica particles. Among the particles containing these metal oxides, it is preferable that the particles are any one selected from alumina particles, magnesium aluminate particles, and titanium oxide particles. This is because such particles containing these metal oxides are readily available and inexpensive.

Among the metal compound particles other than molybdenum compounds contained in the first raw material mixture, it is particularly preferable to use particles containing alumina and/or particles containing magnesium aluminate. This is because such particles exhibit low reactivity with the molybdenum oxide precursor compound, are readily available, and are inexpensive. In addition, when alumina is used as the metal compound particles other than molybdenum compounds, it is preferable that the alumina have an α-crystalline structure.

The metal compound particles other than molybdenum compounds contained in the first raw material mixture preferably have an average particle diameter of 1 mm or less, and more preferably have an average particle diameter of 1 μm to 100 μm. When the metal compound particles contained in the first raw material mixture have an average particle diameter of 1 mm or less, they can more effectively exhibit the function of retaining molten liquefied molybdenum trioxide and the function of protecting the sagger by reducing the contact area between the liquefied molybdenum trioxide and the sagger. When the metal compound particles contained in the first raw material mixture have an average particle diameter of 1 μm or more, such particles can be easily produced, which is preferable. It is more preferable that the metal compound particles contained in the first raw material mixture have an average particle diameter of 2 μm or more.

The first raw material mixture preferably contains 50 mass % to 200 mass % of metal compound particles other than molybdenum compounds, relative to 100 mass % of the molybdenum oxide precursor compound, and more preferably contains 100 mass % to 200 mass % of the metal compound particles other than molybdenum compounds. When the first raw material mixture contains 50 mass % or more of the metal compound particles other than molybdenum compounds, the function of retaining molten liquefied molybdenum trioxide by the metal compound particles, as well as the function of protecting the sagger by reducing the contact area between the liquefied molybdenum trioxide and the sagger, can be exhibited more effectively. Furthermore, when the content of the metal compound particles in the first raw material mixture is 200 mass % or less, the amount of molybdenum trioxide vapor generated by calcining the first raw material mixture becomes smaller, whereby the productivity of molybdenum trioxide powder is not hindered, which is preferable.

The first raw material mixture contains a molybdenum oxide precursor compound and metal compound particles other than molybdenum compounds, and it is preferable that the mixture contains the molybdenum oxide precursor compound and only particles containing one, or two or more kinds of metal oxides selected from alumina particles, magnesium aluminate particles, titania particles, iron oxide particles, zinc oxide particles, and silica particles. When the first raw material mixture contains the molybdenum oxide precursor compound and the particles of one, or two or more of the above metal oxides, no intermediate is generated during the calcining process of calcining the first raw material mixture. Therefore, it is not necessary to set the calcination temperature to a temperature higher than the decomposition temperature of an intermediate, and the calcination temperature can be set to a low temperature of 900° C. or less.

In the first calcining step S11, the calcination conditions, such as the heating rate during calcination of the first raw material mixture, the calcination temperature (maximum temperature), and the calcination time (holding time at the maximum temperature), can be appropriately determined depending on the type and content of the molybdenum oxide precursor compound contained in the first raw material mixture, the type and content of the metal compound particles other than molybdenum compounds, the amount of the first raw material mixture, and the like.

When the first raw material mixture contains only a molybdenum oxide precursor compound and particles containing one, or two or more metal oxides selected from alumina particles, magnesium aluminate particles, titania particles, iron oxide particles, zinc oxide particles, and silica particles, it is preferable that the calcination temperature (maximum temperature) for calcining the first raw material mixture be 800° C. to 1200° C., and more preferably 850° C. to 900° C. When the calcination temperature is 800° C. or higher, the first raw material mixture can be calcined and vaporized in a short time, thereby efficiently generating molybdenum trioxide vapor. When the calcination temperature is 1200° C. or lower, the amount of energy used for producing molybdenum trioxide powder can be suppressed, which is preferable. Furthermore, when the calcination temperature is 900° C. or lower, deterioration of the sagger and the calcination furnace 2 associated with calcining can be suppressed, which is preferable.

When the first raw material mixture contains, in addition to a molybdenum oxide precursor compound and particles containing one, or two or more of the above metal oxides, a metal compound other than the molybdenum oxide precursor compound and the particles containing one, or two or more of the above metal oxides, an intermediate is generated during the calcining process of calcining the first raw material mixture.

Specifically, for example, when the first raw material mixture contains a molybdenum oxide precursor compound and aluminum hydroxide (Al(OH)₃), Al₂(MoO₄)₃ is generated as an intermediate during the calcining process of calcining the first raw material mixture. Therefore, by setting the calcination temperature of the first raw material mixture to a temperature of 1000° C. or higher, which is the decomposition temperature of the intermediate (Al₂(MoO₄)₃) generated during the calcining process, it becomes necessary to generate molybdenum trioxide (MoO₃) vapor from the intermediate. Accordingly, when the first raw material mixture contains a metal compound other than the molybdenum oxide precursor compound and the particles made of one, or two or more of the above metal oxides, it is necessary to set the calcination temperature to higher than 1000° C., for example, in the range of more than 1000° C. and 1100° C. or lower.

In the first calcining step S11, as the sagger used for calcining the first raw material mixture, there can be used, for example, a conventionally known sagger containing mullite-cordierite (a mixture of mullite (3Al₂O₃·2SiO₂) and cordierite (2MgO·2Al₂O₃·5SiO₂)), mullite, alumina, or SiC.

### (First Cooling Step S12)

In the first cooling step S12, molybdenum trioxide powder is produced by cooling the molybdenum trioxide vapor generated in the first calcining step S11.

In the present embodiment, as shown in FIG. 1, by discharging the gas in the cooling pipe 3 through the dust collector 4 by the exhaust device 8, outside air is blown into the cooling pipe 3 from the opening-degree control damper 6. The outside air blown into the cooling pipe 3 cools the molybdenum trioxide vapor generated in the calcining furnace 2, thereby pulverizing it.

In the method for producing molybdenum trioxide powder of the present embodiment, it is preferable that, in the first cooling step S12, molybdenum trioxide powder having an average particle diameter of 1 nm or more and 100 nm or less be produced. Molybdenum trioxide powder having an average particle diameter of 100 nm or less exhibits good reactivity with sulfur, and can therefore be preferably used as a precursor of molybdenum sulfide. The average particle diameter of the molybdenum trioxide powder is more preferably 50 nm or less. Further, molybdenum trioxide powder having an average particle diameter of 1 nm or more can be produced with good yield. The average particle diameter of the molybdenum trioxide powder is more preferably 1 nm or more.

In the first cooling step S12, it is preferable to produce molybdenum trioxide powder having a specific surface area of 10 m²/g or more and 500 m²/g or less, as measured by the BET method. Molybdenum trioxide powder having a specific surface area of 10 m²/g or more exhibits good reactivity with sulfur, and can therefore be preferably used as a precursor of molybdenum sulfide. It is more preferable that the specific surface area of the produced molybdenum trioxide powder be 30 m²/g or more. Further, molybdenum trioxide powder having a specific surface area of 500 m²/g or less can be produced with good yield. It is more preferable that the specific surface area of the molybdenum trioxide powder be 300 m²/g or less.

The average particle diameter and specific surface area of the molybdenum trioxide powder produced in the first cooling step S12 can be adjusted by appropriately controlling conditions such as the content of the molybdenum oxide precursor compound in the first raw material mixture, the cooling rate of the molybdenum trioxide vapor in the cooling pipe 3, and the calcination temperature of the first raw material mixture.

It is preferable that, in the first cooling step S12, molybdenum trioxide powder containing a β-crystal structure is produced. The reason is that molybdenum trioxide powder containing a β-crystal structure is less stable than molybdenum trioxide powder with an α-crystal structure and has higher reactivity with sulfur, making it preferable for use as a precursor for molybdenum sulfide.

### (First Crushing Step S13)

In the first crushing step S13, the residue containing a metal oxide derived from the metal compound particles which remains in the sagger after the first firing step S11, is crushed to obtain first crushed particles.

As a method for crushing the residue remaining in the sagger, any known method can be used, such as a method of employing one or two or more crushing devices selected from a roll crusher, pin mill, or hammer mill.

The first crushed particles (primary particles) formed in the first crushing step S13 preferably have an average particle diameter of 2 mm or less, and more preferably have an average particle diameter of 1 μm or more and 1000 μm or less. When the first crushed particles formed in the first crushing step S13 have an average particle diameter of 2 mm or less, and the first crushed particles are used as a material of the second raw material mixture in the second calcining step S21, the function of retaining molten liquefied molybdenum trioxide and the function of protecting the sagger by reducing the contact area between the molten liquefied molybdenum trioxide and the sagger are more effectively exhibited. Moreover, first crushed particles having an average particle diameter of 1 μm or more are preferable because the residue containing metal oxides derived from metal compound particles can be easily and efficiently obtained by a method using a roll crusher. The first crushed particles are more preferably particles having an average particle diameter of 0.7 mm or more.

The residue remaining in the sagger after the first calcining step S11 contains metal oxides derived from the metal compound particles used in the first calcining step S11, and is in a lumped shape as a result of performing the first calcining step S11.

The residue remaining in the sagger after the first calcining step S11 may contain molybdenum oxide precursor compounds that were not vaporized and remained in the sagger during the first calcining step S11. Even when the residue contains molybdenum oxide precursor compounds, it can be crushed into the first crushed particles in the same manner as when no molybdenum oxide precursor compounds are contained. Moreover, even the first crushed particles containing molybdenum oxide precursor compounds can be used as a material of the second raw material mixture, without causing any problems in the second calcining step S21.

When the first raw material mixture contains only a molybdenum oxide precursor compound and particles containing one, or two or more metal oxides selected from alumina particles, magnesium aluminate particles, titania particles, ferric oxide particles, zinc oxide particles, and silica particles, the particles made of metal oxides do not volatilize in the first calcining step S11, so substantially all of the particles made of metal oxides used as a material in the first raw material mixture remain in the sagger. Therefore, when the entire amount of the first crushed particles produced in the first crushing step S13 is used as a material of the second raw material mixture in the second calcining step S21, substantially all of the particles made of metal oxides used as a material in the first raw material mixture can be reused in the second calcining step S21.

### (Second Calcining Step S21)

In the second calcining step S21, the second raw material mixture, which contains a molybdenum oxide precursor compound and the first crushed particles formed in the first crushing step S13, is charged in a sagger and calcined in the calcining furnace 2 shown in FIG. 1. The molybdenum oxide precursor compound is vaporized to generate molybdenum trioxide vapor

The second calcining step S21 can be performed in the same manner as the first calcining step S11, except that the first crushed particles formed in the first crushing step S13 are used instead of the metal compound particles other than the molybdenum compound that were used as materials in the first raw material mixture during the first calcining step S11.

Therefore, in the second calcining step S21, the sagger, the type and content of the molybdenum oxide precursor compound in the second raw material mixture (i.e., the type and content of the molybdenum oxide precursor compound in the first raw material mixture), and the calcination conditions can all be the same as those in the first calcining step S11. However, if necessary, some or all of the sagger, the type and content of the molybdenum oxide precursor compound, and the calcination conditions may be changed. Furthermore, as the second raw material mixture, a mixture that contains, in addition to the molybdenum oxide precursor compound and the first crushed particles, metal compound particles other than the first crushed particles and the molybdenum compound, may also be used.

The second raw material mixture preferably contains 50 mass % or more and 200 mass % or less of the first crushed particles (or, when containing metal compound particles other than the first crushed particles and the molybdenum compound, the total of these metal compound particles and the first crushed particles) relative to 100 mass % of the molybdenum oxide precursor compound, and more preferably contains 100 mass % or more and 200 mass % or less. When the content of the first crushed particles (or, when containing metal compound particles other than the first crushed particles and the molybdenum compound, the total of these metal compound particles and the first crushed particles) is 50 mass % or more, the function of retaining molten, liquefied molybdenum trioxide by the first crushed particles (or, when containing metal compound particles other than the first crushed particles and the molybdenum compound, the total of these metal compound particles and the first crushed particles) and the function of protecting the sagger by reducing the contact area between the liquefied molybdenum trioxide and the sagger, are more effectively exhibited, similarly to the case in which the metal compound particles in the first raw material mixture are 50 mass % or more. Furthermore, when the content of the first crushed particles (or, when containing metal compound particles other than the first crushed particles and the molybdenum compound, the total of these metal compound particles and the first crushed particles) is 200 mass % or less, similarly to the case in which the content of metal compound particles in the first raw material mixture is 200 mass % or less, the amount of molybdenum trioxide vapor generated by calcination is not excessively reduced, so the productivity of molybdenum trioxide powder is not adversely affected, which is preferable.

The second raw material mixture contains the molybdenum oxide precursor compound and the first crushed particles, and may contain only the molybdenum oxide precursor compound and the first crushed particles, or may further contain metal compound particles other than the molybdenum oxide precursor compound and the first crushed particles.

The metal compound particles other than the molybdenum oxide precursor compound and the first crushed particles, which may be contained in the second raw material mixture, can be the same as those metal compound particles other than the molybdenum compound that may be included in the first raw material mixture.

The second raw material mixture preferably contains only the molybdenum oxide precursor compound and the first crushed particles. The first crushed particles do not form any intermediates during the second calcining step S21. Therefore, when the second raw material mixture contains only the molybdenum oxide precursor compound and the first crushed particles, the calcination temperature can be set at a low temperature of 900° C. or lower, which is preferable.

In the second calcining step S21, the calcination conditions for calcinating the second raw material mixture, such as the heating rate, calcination temperature (maximum temperature), and calcination time (holding time at the maximum temperature), can be appropriately determined according to the type and content of the molybdenum oxide precursor compound and the first crushed particles contained in the second raw material, the type and content of metal compounds other than the molybdenum oxide precursor compound and the first crushed particles which may be contained in the second raw material mixture, and the amount of the second raw material mixture.

When the second raw material mixture contains only the molybdenum oxide precursor compound and the first crushed particles, it is preferable to set the calcination temperature (maximum temperature) for calcining the second raw material mixture to 800° C. to 1200° C., and more preferably to 850° C. to 900° C., in the same manner as when calcining a first raw material mixture that contains only the molybdenum oxide precursor compound and particles containing one, or two or more metal oxides selected from aluminum oxide particles, magnesium aluminate particles, titanium oxide particles, iron oxide particles, zinc oxide particles, and silica particles.

### (Second Cooling Step S22)

In the second cooling step S22, the molybdenum trioxide vapor generated in the second calcining step S21 is cooled to generate molybdenum trioxide powder, in the same manner as in the first cooling step S12

In the second cooling step S22, for the same reasons as in the first cooling step S12, it is preferable to generate molybdenum trioxide powder having an average particle diameter of 5 nm or more and 100 nm or less and/or a BET specific surface area of 10 m²/g or more and 500 m²/g or less.

In the second cooling step S22, for the same reasons as in the first cooling step S12, it is also preferable to generate molybdenum trioxide powder containing a β-crystalline structure.

### (Second Crushing Step S23)

In the second crushing step S23, similarly to the manner in which the residue containing metal oxides derived from metal compound particles which remain in the sagger after the first calcining step S11 is crushed in the first crushing step S13, the residue containing metal oxides derived from the first crushed particles which remain in the sagger after the second calcining step S21 is crushed to obtain second crushed particles.

The second crushed particles (primary particles) formed in the second crushing step S23 preferably have an average particle diameter of 2 mm or less, for the same reasons as the first crushed particles formed in the first crushing step S13, and more preferably have an average particle diameter of 1 μm or more and 1000 μm or less.

The residue remaining in the sagger after the second calcining step S21 contains a metal oxide derived from the first crushed particles used in the second calcining step S21, and by performing the second calcining step S21, it is again formed into a lump-shape. The residue remaining in the sagger after the second calcining step S21 may contain molybdenum oxide precursor compounds that did not vaporize in the second calcining step S21 and remain in the sagger. Even when the residue contains molybdenum oxide precursor compounds, it can be crushed to form second crushed particles in the same manner as when no molybdenum oxide precursor compounds are contained. Even second crushed particles containing the molybdenum oxide precursor compound can be used as a material of the second raw material mixture, without causing any problems in the second or subsequent second calcining step S21.

When the second raw material mixture contains only the molybdenum oxide precursor compound and the first crushed particles, the first crushed particles do not vaporize during the second calcining step S21. Therefore, substantially all of the first crushed particles used as a material in the second raw material mixture remain in the sagger. Therefore, when the entirety of the first crushed particles produced in the second crushing step S23 is used as a material for the second raw material mixture in the second implementation of the second calcining step S21, substantially all of the first crushed particles used in the first implementation of the second calcining step S21 can be reused.

In the present embodiment, as shown in FIG. 2, after the first implementation of the second crushing step S23, the second calcining step S21, the second cooling step S22, and the second crushing step S23 may be carried out once or multiple times in this order.

The method for producing molybdenum trioxide powder according to the present embodiment includes, as shown in FIG. 2, a first calcining step S11, a first cooling step S12, a first crushing step S13, a second calcining step S21, a second cooling step S22, and a second crushing step S23. In the method for producing molybdenum trioxide powder according to the present embodiment, in the first calcining step S11, metal compound particles other than molybdenum compounds are used together with a molybdenum oxide precursor compound, in the first crushing step S13, the residue containing a metal oxide derived from the metal compound particles which remains in the sagger after the calcination is crushed to obtain first crushed particles, and in the second calcining step S21, the first crushed particles are used together with a molybdenum oxide precursor compound.

Accordingly, in the method for producing molybdenum trioxide powder of the present embodiment, the residue containing a metal oxide derived from the metal compound particles other than the molybdenum compound used in the first calcining step S11 is crushed in the first crushing step S13 to be formed into first crushed particles, and is reused as a material in the second calcining step S21.

Therefore, in the method for producing molybdenum trioxide powder according to the present embodiment, the material cost can be reduced as compared with the case where the residue containing a metal oxide derived from metal compound particles other than the molybdenum compound contained in the first raw material mixture is not reused.

In the method for producing molybdenum trioxide powder according to the present embodiment, the residue remaining in the sagger after calcination is crushed to form first crushed particles, which are then reused in the second calcining step S21. Accordingly, it is not necessary to dispose of the residue remaining in the sagger after calcination, and unlike the case where the residue remaining in the sagger after calcination is disposed of, no environmental load or disposal cost associated with such disposal arises.

Although the preferred embodiments of the invention have been described in detail above, the invention is not limited to the specific embodiments, and various modifications and changes may be made without departing from the spirit and scope of the invention as set forth in the claims.

### Example 1

Molybdenum trioxide powder was produced using the production apparatus 1 shown in FIG. 1 in accordance with the following procedure.

### (First Calcining Step S11)

A first raw material mixture containing 500 g of molybdenum trioxide (MoO₃) as a molybdenum oxide precursor compound (manufactured by Nihon Inorganic Chemical Co., Ltd., average particle diameter: 5 μm) and 500 g of alumina (Al₂O₃) particles, which are metal compound particles other than molybdenum compounds (manufactured by Sumitomo Chemical Co., Ltd., average particle diameter: 4.8 μm).

The first raw material mixture was charged in a sagger containing a mullite-cordierite mixture and fired in the calcining furnace 2 to generate molybdenum trioxide vapor. The heating rate during calcination of the first raw material mixture was set to 5° C./min, the calcination temperature (maximum temperature) was 900° C., and the calcination time (holding time at the maximum temperature) was 10 hours.

### (First Cooling Step S12)

By exhausting the gas in the cooling pipe 3 via the dust collection device 4 by the exhaust device 8 shown in FIG. 1, outside air was blown into the cooling pipe 3 from the adjustable opening-degree damper 6 at a flow rate of 4.4 m³/min. Thereby, the molybdenum trioxide vapor generated in the calcining furnace 2 during the first calcining step S11 was cooled, and molybdenum trioxide powder was produced.

Thereafter, the molybdenum trioxide powder collected by the dust collection device 4 was recovered, and the average particle diameter and the BET specific surface area of the molybdenum trioxide powder were measured by the method shown below. The results are shown in Table 2.

### [Method for Measuring Average Particle Diameter]

The molybdenum trioxide powder was observed using a transmission electron microscope (TEM) at a magnification of 50,000×, and for the smallest unit particles on the obtained two-dimensional images (i.e., primary particles), the major axis (the Feret diameter of the longest observed portion) and the minor axis (the Feret diameter in the direction perpendicular to the longest portion) were measured. The average of the major axis and minor axis of each primary particle was calculated and defined as the primary particle diameter. Thereafter, the primary particle diameters of 50 molybdenum trioxide powder particles randomly selected from the two-dimensional images were calculated, and the average value was calculated as the average particle diameter of the molybdenum trioxide powder.

### [Method for Measuring Specific Surface Area by BET Method]

Using a specific surface area meter (Microtrac BEL, BELSORP-mini), the amount of nitrogen gas adsorbed by the molybdenum trioxide powder was measured by the BET method. From the measurement results, the surface area per 1 g of molybdenum trioxide powder was calculated, and this was defined as the specific surface area (m²/g) of the molybdenum trioxide powder.

### (First Crushing Step S13)

The residue remaining in the sagger after the first calcining step S11 was crushed using a roll crusher to form first crushed particles (primary particles), and the average particle diameter of the first crushed particles was measured by the following method. The results are shown in Table 2.

The average particle diameter of the first crushed particles was calculated using the wet particle size distribution of a dispersion prepared by charging the first crushed particles in a 10% aqueous solution of sodium hexametaphosphate and dispersing them using ultrasonic waves, and measured with a laser diffraction particle size distribution analyzer (device name: MASTERIZER 3000, Malvern Co., Ltd.).

In addition, the composition of the first crushed particles was identified by elemental analysis using an X-ray fluorescence analyzer (XRF apparatus) (product name: Primus IV, Rigaku Corporation). As a result, it was confirmed that the first crushed particles (residue) contained 90 mass % or more of alumina (Al₂O₃) and were in a shape of lump in which the particles adhered to each other.

In addition, the first crushed particles and the alumina (Al₂O₃) particles as the metal compound particles other than the molybdenum compound used in the first raw material mixture were subjected to crystal structure analysis using the X-ray diffraction (XRD) charts obtained with an X-ray diffractometer (product name: SmartLab, Rigaku Corporation), respectively. As a result, no significant difference was observed between the crystal structure of the first crushed particles and the crystal structure of the alumina (Al₂O₃) particles as the metal compound particles other than the molybdenum compound.

### (Second Calcining Step S21)

Except that the first crushed particles formed in the first crushing step S13 were used instead of the alumina (Al₂O₃) particles used as the material of the first raw material mixture in the first calcining step S11, the same steps as in the first calcining step S11 were performed.

### (Second Cooling Step S22)

In the same manner as the case where the molybdenum trioxide powder was generated in the first cooling step S12, molybdenum trioxide powder was generated by cooling the molybdenum trioxide vapor produced in the second calcining step S21.

Thereafter, the molybdenum trioxide powder collected by the dust collection device 4 was recovered, and, as in the first cooling step S12, the average particle diameter and the BET-specific surface area of the molybdenum trioxide powder were measured. The results are shown in Table 2.

### (Second Crushing Step S23)

In the same manner as the case where the residue remaining in the sagger after the first calcining step S11 was crushed in the first crushing step S13, the residue remaining in the sagger after the second calcining step S21 was crushed to form second crushed particles. Then, as in the first crushing step S13, the average particle diameter of the second crushed particles was measured. The results are shown in Table 2.

Thereafter, the second calcining step S21, the second cooling step S22, and the second crushing step S23 were repeated twice in this order.

In the second implementation of the second calcining step S21, the second crushed particles obtained in the first implementation of the second crushing step S23 were used instead of the first crushed particles. In the third implementation of the second calcining step S21, the second crushed particles obtained in the second implementation of the second crushing step S23 were used. Further, in the second implementation of the second crushing step S23, the residue containing metal oxides derived from the second crushed particles obtained in the first implementation of the second crushing step S23 was crushed instead of the residue containing metal oxides derived from the first crushed particles. In the third implementation of the second crushing step S23, the residue containing metal oxides derived from the second crushed particles obtained in the second implementation of the second crushing step S23 was crushed.

Each time the second cooling step S22 was performed, the average particle diameter and the specific surface area measured by the BET method were measured in the same manner as in the first cooling step S12. The results are shown in Table 2.

Also, each time the second crushing step S23 was performed, the average particle diameter of the second crushed particles was measured in the same manner as in the first crushing step S13. The results are shown in Table 2

### Example 2

Molybdenum trioxide powder was produced in the same manner as in Example 1 except that 500 g of magnesium aluminate (MgAl₂O₄) particles (manufactured by Itochu Corporation, average particle diameter: 20 μm) were used instead of the alumina (Al₂O₃) particles as the metal compound particles other than molybdenum compounds in the first calcining step S11.

In Example 2, the composition of the first crushed particles obtained in the first crushing step S13 was identified by the same method as in Example 1. As a result, it was confirmed that the first crushed particles (residue) contain only magnesium aluminate (MgAl₂O₄) and were in a shape of lump in which the particles adhered to each other.

In addition, the first crushed particles and the magnesium aluminate (MgAl₂O₄) particles, which were used as the metal compound particles other than the molybdenum compound in the first raw material mixture, were subjected to crystal structure analysis in the same manner as in Example 1. As a result, no significant difference was observed between the crystal structure of the first crushed particles and the crystal structure of the magnesium aluminate (MgAl₂O₄) particles as the metal compound particles other than the molybdenum compound.

### Example 3

Molybdenum trioxide powder was produced in the same manner as in Example 1 except that the calcination temperature (maximum temperature) for calcining the first raw material mixture in the first calcining step S11 and the calcination temperature (maximum temperature) for calcining the second raw material mixture in the second calcining step S21 were set to 850° C.

### Comparative Example 1

Only the first calcining step S11 and the first cooling step S12 were performed in the same manner as in Example 1 except that, instead of alumina (Al₂O₃) particles as metal compound particles other than molybdenum compounds, 750 g of aluminum hydroxide (Al(OH)₃) particles (manufactured by Nippon Light Metal Co., Ltd., average particle size 1 μm) were used and calcined at a calcination temperature (maximum temperature) of 1100° C., to produce molybdenum trioxide powder.

Next, the durability of the saggers used in the production methods of molybdenum trioxide powder in Examples 1 to 3 was measured by the following method and evaluated according to the criteria shown below.

### [Method for Measuring the Durability of the Saggers]

It was visually confirmed whether obvious corrosion was present in the sagger, and whether the sagger was in an unusable state due to cracks present in the sagger. Here, “obvious corrosion” means a state in which the wall of the sagger is visibly eroded.

Further, “unusable due to cracks” means a state in which cracks observed on the inside of the sagger are also visible from the outside.

### [Criteria for Evaluating the Durability of the Saggers]

A: No obvious corrosion is present in the sagger, and the sagger is not in an unusable state due to cracks present in the sagger.
B: Obvious corrosion is present in the sagger; however, the sagger is not in an unusable state due to cracks present in the sagger.
C: No obvious corrosion is present in the sagger, but the sagger is in an unusable state due to cracks present in the sagger, or obvious corrosion is present in the sagger and the sagger is in an unusable state due to cracks present in the sagger.

The materials used for the production of molybdenum trioxide powder and the calcination temperatures in Examples 1 to 3 and Comparative Example 1 are shown in Table 1.

TABLE 1

| | Molybdenum Oxide | Metal Compound Particles other than | | | |
|---|---|---|---|---|---|
| | Precursor Compound | Molybdenum Compounds | | | Calcination |
| | MoO₃ | Al₂O₃ | MgAl₂O₄ | Al(OH)₃ | temperature |
| | [g] | [g] | [g] | [g] | [° C.] |
| Example 1 | 500 | 500 | | — | 900 |
| Example 2 | 500 | | 500 | — | 900 |
| Example 3 | 500 | 500 | | — | 850 |
| Comparative | 500 | — | — | 750 | 1100 |
| Example 1 | | | | | |

In Examples 1 to 3 and Comparative Example 1, the average particle diameter of the molybdenum trioxide powder obtained after each cooling step and the specific surface area as measured by the BET method are shown in Table 2. Further, in Examples 1 to 3, the average particle diameter (primary particles after crushing) of the first crushed particles (or the second crushed particles) obtained after each crushing step is shown in Table 2.

Further, in Examples 1 to 3 and Comparative Example 1, it was confirmed, using an X-ray diffraction (XRD) apparatus (trade name: SmartLab, manufactured by Rigaku Corporation), whether the molybdenum trioxide powder obtained after each cooling step contained a β-crystal structure. The results are shown in Table 2.

TABLE 2

| | | | | | | | | Second crushing |
|---|---|---|---|---|---|---|---|---|
| | | | | First | | | | step |
| | | | | crushing | Second cooling step | | | (First |
| | First cooling step | | | step | (First implementation) | | | implementation) |
| | Average | Specific | | Crushed | Average | Specific | | Crushed |
| | particle | surface | | particle | particle | surface | | particle |
| | diameter | area | | diameter | diameter | area | | diameter |
| | [nm] | [m²/g] | β-crystal | [μm] | [μm] | [m²/g] | β-crystal | [μm] |
| Example 1 | 15 | 160 | Present | 5 | 15 | 160 | Present | 5 |
| Example 2 | 15 | 160 | Present | 20 | 15 | 160 | Present | 20 |
| Example 3 | 15 | 160 | Present | 5 | 15 | 160 | Present | 5 |
| Comparative | 15 | 160 | Present | — | — | — | — | — |
| Example 1 | | | | | | | | |

| | | | | Second | | | | Second | |
|---|---|---|---|---|---|---|---|---|---|
| | | | | crushing | | | | crushing | |
| | | | | step | | | | step | |
| | Second cooling step | | | (Second | Second cooling step | | | (Third | |
| | (Second implementation) | | | implementation) | (Third implementation) | | | implementation) | |
| | Average | Specific | | Crushed | Average | Specific | | Crushed | Durability |
| | particle | surface | | particle | particle | surface | | particle | evaluation |
| | diameter | area | | diameter | diameter | area | | diameter | of |
| | [μm] | [m²/g] | β-crystal | [μm] | [μm] | [m²/g] | β-crystal | [μm] | sagger |
| Example 1 | 15 | 160 | Present | 5 | 15 | 160 | Present | 5 | A |
| Example 2 | 15 | 160 | Present | 20 | 15 | 160 | Present | 20 | A |
| Example 3 | 15 | 160 | Present | 5 | 15 | 160 | Present | 5 | A |
| Comparative | — | — | — | — | — | — | — | — | B |
| Example 1 | | | | | | | | | |

In the production methods of the molybdenum trioxide powders in Examples 1 to 3, after performing the first calcining step S11, the first cooling step S12, and the first crushing step S13, the second calcining step S21, the second cooling step S22, and the second crushing step S23 were repeatedly performed three times. Accordingly, in the production methods of the molybdenum trioxide powders in Examples 1 to 3, in the first calcining step S11, metal compound particles other than molybdenum compounds were used together with the molybdenum oxide precursor compound, in the first crushing step S13, the residue containing a metal oxide derived from the metal compound particles remaining in the sagger after calcination was crushed to obtain first crushed particles, and in the second calcining step S21, the first crushed particles were used together with the molybdenum oxide precursor compound.

Accordingly, in the production methods of the molybdenum trioxide powders in Examples 1 to 3, the residual material containing a metal oxide derived from the metal compound particles other than molybdenum compounds used in the first calcining step S11 was crushed in the first crushing step S13 to form first crushed particles, and was reused as a material in the second calcining step S21. Further, the residue containing metal oxides derived from the first crushed particles used in the first (second) implementation of the second calcining step S21 was crushed in the first (second) implementation of the second crushing step S23 to form the second crushed particles, which were then reused as a material in the second (third) implementation of the second calcining step S21.

Accordingly, in the production methods of molybdenum trioxide powder of Examples 1 to 3, the material cost can be reduced as compared with Comparative Example 1, in which the residue containing metal oxides derived from the metal compound particles other than the molybdenum compound (aluminum hydroxide (Al(OH)₃) particles) contained in the first raw material mixture is not reused.

In the production methods of molybdenum trioxide powders in Examples 1 to 3, the residue remaining in the sagger after calcination was crushed to form first crushed particles (or second crushed particles), which were then reused in the second calcining step S21. Therefore, there is no need to dispose of the residue remaining in the sagger after calcination, and, unlike in cases where the residue remaining in the sagger after calcination is disposed of, no environmental burden or disposal cost arises.

As shown in Table 2, in the production methods of molybdenum trioxide powders in Examples 1 to 3, no differences were observed in the average particle diameter of the molybdenum trioxide powders obtained after each cooling step or in the specific surface area measured by the BET method.

This confirmed that, even when metal compound particles other than molybdenum compounds were used together with the molybdenum oxide precursor compound, or when the first crushed particles (or second crushed particles) were used together with the molybdenum oxide precursor compound, molybdenum trioxide powders of comparable quality could be obtained.

As shown in Table 2, in the production methods of molybdenum trioxide powders in Examples 1 to 3, compared to the production method of the molybdenum trioxide powder in Comparative Example 1, it was confirmed that the durability of the sagger was improved and the deterioration of the sagger could be suppressed.

This is presumed to be because, in Examples 1 to 3, the calcination temperature is 900° C. or lower, thereby suppressing the deterioration of the sagger associated with calcining.
Furthermore, in the production methods of molybdenum trioxide powders in Examples 1 to 3, since the calcination temperature is 900° C. or lower, the amount of energy used in producing the molybdenum trioxide powder can be reduced.

As shown in Table 2, in the production methods of molybdenum trioxide powders in Examples 1 to 3, it was confirmed that molybdenum trioxide powders containing a β-crystal structure were generated in the first cooling step and second cooling step.

What is claimed is:

1. A method for producing molybdenum trioxide powder, the method comprising:
a first calcining step of charging a first raw material mixture, which contains a molybdenum oxide precursor compound and metal compound particles other than molybdenum compounds, in a sagger, calcining the mixture, and vaporizing the molybdenum oxide precursor compound to form molybdenum trioxide vapor;
a first cooling step of cooling the molybdenum trioxide vapor produced in the first calcining step to generate molybdenum trioxide powder;
a first crushing step of crushing a residue containing a metal oxide derived from the metal compound particles which remains in the sagger after the first calcining step, to obtain first crushed particles;
a second calcining step of charging a second raw material mixture, which contains the molybdenum oxide precursor compound and the first crushed particles, in a sagger, calcining the mixture, and vaporizing the molybdenum oxide precursor compound to form molybdenum trioxide vapor;
a second cooling step of cooling the molybdenum trioxide vapor produced in the second calcining step to generate molybdenum trioxide powder;
a second crushing step of crushing a residue containing a metal oxide derived from the first crushed particles which remains in the sagger after the second calcining step, to obtain second crushed particles.

2. The method for producing molybdenum trioxide powder according to claim 1, wherein the average particle diameter of the first crushed particles and the second crushed particles is 1 mm or less.

3. The method for producing molybdenum trioxide powder according to claim 1, wherein the metal compound particles are one, or two or more selected from alumina particles, magnesium aluminate particles, titanium oxide particles, iron oxide particles, zinc oxide particles, and silica particles.

4. The method for producing molybdenum trioxide powder according to claim 3, wherein the first raw material mixture contains the molybdenum oxide precursor compound and the metal compound particles, and in the first calcining step, calcining is performed at a temperature of 800° C. or higher and 1200° C. or lower, and
the second raw material mixture contains the molybdenum oxide precursor compound and the first crushed particles, and in the second calcining step, calcining is performed at a temperature of 800° C. or higher and 1200° C. or lower.

5. The method for producing molybdenum trioxide powder according to claim 3, wherein the first raw material mixture contains the metal compound particles in an amount of 50 to 200 mass % relative to 100 mass % of the molybdenum oxide precursor compound, and the second raw material mixture contains the first crushed particles in an amount of 50 to 200 mass % relative to 100 mass % of the molybdenum oxide precursor compound.

6. The method for producing molybdenum trioxide powder according to claim 1, wherein molybdenum trioxide powder having an average particle diameter of 5 nm or greater and 100 nm or less is produced in the first cooling step and the second cooling step.

7. The method for producing molybdenum trioxide powder according to claim 1, wherein molybdenum trioxide powder having a specific surface area of 10 m²/g or greater and 500 m²/g or less, measured by the BET method, is produced in the first cooling step and the second cooling step.

8. The method for producing molybdenum trioxide powder according to claim 1, wherein molybdenum trioxide powder containing a β-crystal structure is produced in the first cooling step and the second cooling step.
